(19) United States
(12) Patent Application Publication
(10) Pub. No.: US 2007/0055949 A1
(43) Pub. Date: Mar. 8, 2007

(54) METHODS AND APPARATUS FOR RFID INTERFACE CONTROL

(76) Inventor: Nicholas Thomas, Columbia, IL (US)

Correspondence Address: NICHOLAS J. THOMAS, 2425 HANOVER, COLUMBIA, IL, 62220, US

(21) Appl. No.: 11/308,546

(22) Filed: Apr. 5, 2006

Related U.S. Application Data
(63) Continuation-in-part of application No. 10/905,999, filed on Jan. 29, 2005, now abandoned.

(51) Int. Cl. G06F 3/00

(52) U.S. Cl. 715/863

(57) ABSTRACT

Methods and apparatus for interacting with a computer system using hand gestures, tangible objects that contain a tracking RFID tag, tangible objects that contain no RFID tag, and holographic or virtually displayed objects. This invention allows any real or virtually displayed object to be used as a tool for interaction with a computer system. The system provides an entirely user configurable interface for a computer and allows user metadata to be easily carried by the user from one computer to the next.

### CROSS REFERENCE TO RELATED APPLICATION

This application is a continuation-in-part of U.S. patent application Ser. No. 10/905,999 filed on Jan. 29, 2005 which is hereby incorporated by reference.

### BACKGROUND OF THE INVENTION

This invention relates generally to wireless communication systems and, more particularly, to systems that incorporate radio frequency identification (RFID) components to input data into a system.

At least some known standardized computer user interfaces include an input device, such as a mouse, to control the location of a cursor on a video display connected to the computer. However, known user interfaces may fail to provide a seamless connection of the user with the software being executed via the computer. For example, known graphical user interfaces are restrained by the standard keyboard and/or mouse set-up arrangements commonly employed today. More specifically, the current model of user interaction with a computer system may be severely limited by hardware constraints and industry wide standards that have been adopted.

For example, when a mouse is used, typically, cursor location is controlled by movement of the mouse across a surface. The mouse includes a tracking device for measuring the movement of the mouse across the surface. This movement is relayed to the computer where it is translated into a corresponding movement of the cursor on the display. In addition, known mousse include at least one button for controlling switching functions that may be used, for example, to activate a function or command identified by the cursor location.

Generally, known mouses are not ergonomically synchronized with the human form because of the differences in size and shape of the human hand. As a result, users have experienced increased incidents of carpel tunnel syndrome as they struggle to conform their hands to the currently available designs. Moreover, the additional costs of a new hardware device and the reluctance of users to learn interface techniques outside of the standard tools generally inhibits the development of new user interface tools.

Several attempts have been made to solve the above-described interface problems. One solution to these problems is to integrate the functions of a computer mouse with the individual user's hand. For example, U.S. Pat. Nos. 5,444,462, and 6,097,369 each describe a glove to be worn on a user's hand wherein the glove includes micro-switches mounted next to a joint of the index finger and on opposite sides of the wrist. The switches translate up and down movement of the index finger and side to side movement of the wrist into vertical and horizontal movements, respectively, of a cursor on a computer display. Buttons are provided on the other fingers to provide mouse clicking functions and to turn the glove on and off. These buttons are activated by the thumb. Although the device described by Wambach does not require a surface over which a tracking device must be moved, it does require a great deal of skill and considerable practice for the user to be able to control a cursor on a video display with any degree of accuracy. Further, the device must be manually activated prior to use and manually deactivated after use so that hand movements are not inadvertently translated into cursor movements on the screen while the user is typing.

U.S. Pat. No. 6,452,585 describes a radio transmitter/receiver tracking system incorporated into a glove. Within the system described in the '585 Patent, the user's hand movements are mapped onto a computer screen to display a virtual hand that the user can manipulate to alter virtual objects. However, within such a system, the glove requires the use of batteries s that are generally heavy and bulky and the size of the glove may limit the number of users that could use the system. Moreover, users that frequently use computers may not like to be encumbered by an additional device that needs to be work as they complete their day-to-day activities.

Other known models provide basic mappings of the human hand as a form of interface to a software system. These other models however only record and repeat real world actions to provide user input for robotic systems. Some models allow the specification of objects in their model in which the object's interaction provides different functions of the software in use. These models however are still restrained to a single user interface.

### BRIEF DESCRIPTION OF THE INVENTION

In one embodiment, the system tracks the movement of a user's hand using a plurality of transmitters embedded into the user's hand. The transmitters are activated by the system when a user enters the RF field of the system. The system determines the location of each transmitter by using multiple signals received.

In another embodiment, transmitters are embedded into the user's hand in multiple locations. The transmitters are selectively activated by the system to transmit data. A number of receivers are used to receive wireless communications from these transmitters. A processor is coupled to these receivers to determine the location of each transmitter in the user's hand.

### BRIEF DESCRIPTION OF THE DRAWINGS

FIG. 1 is a perspective view of an exemplary radio frequency identification (RFID) interposer.

FIG. 2 is a schematic block diagram of an interaction model for use in interfacing with a computer system using the RFID tags shown in FIG. 1.

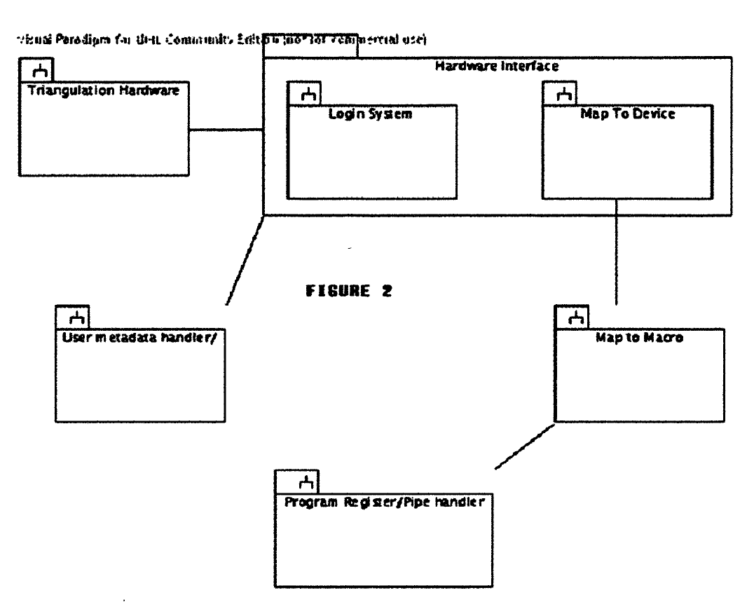

### DETAILED DESCRIPTION OF THE INVENTION

As used herein, an element or step recited in the singular and proceeded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

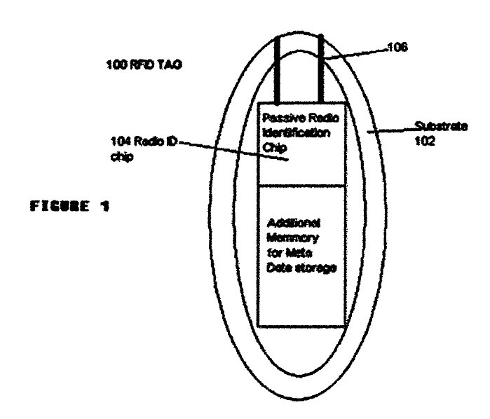

FIG. 1 is a perspective view of an exemplary radio frequency identification (RFID) tag or transponder 100. In the exemplary embodiment, tag 100 includes a substrate 102, a radio frequency identification circuit 104, and at least one electrically conductive lead 106 coupled to the substrate 102. The substrate may be fabricated from a thin film of a variety of insulating materials, such as, but not limited to, a polycarbonate material.

The radio frequency identification circuit 104 is electrically coupled to radio frequency identification circuit 104. In the exemplary embodiment, radio frequency identification circuit 104 is a passive circuit. In various alternative embodiments, radio frequency identification circuit 104 is a semi-passive or active circuit that includes a battery (not shown) or capacitive storage device coupled to radio frequency identification circuit 104. In various embodiments, a sensor (not shown) is electrically coupled to radio frequency identification circuit 104 for communicating environmental data proximate the sensor. The sensor is of micro-mechanical design such that the sensor is incorporated into radio frequency identification circuit 104 or is a separate device that is communicatively coupled to radio frequency identification circuit 104. The sensor is used to read environmental or other conditions in the vicinity of the sensor, for example, but not limited to, vibration, shock, temperature, pressure, and humidity.

The current invention facilitates enhanced interaction with any computer system. The invention uses unique radio identification signals to map the movements of each finger of a user's hand and the relative orientation of the user's wrist to provide a way to track the user's interaction with a system, such as a holographic system, having no tangible control mechanisms. In alternative embodiments, the system provides an interface for use with non-holographic systems.

Initially, RFID tags 100 are embedded under the skin of the user's hand in multiple locations across the user's hand. In an alternative embodiment, a user may wear a glove including RFID tags 100 embedded therein. The locations of the RFID tags 100 enables the movement of all five fingers and the orientation of the wrist to be mapped by a reader or interrogator, and subsequently used by a computer system as a form of interface for that computer system. The interrogator includes a transceiver and an antenna. The RFID tag 100 includes a transceiver and may include an antenna. In operation, the interrogator emits and receives electromagnetic radio signals generated by the transceiver to activate the RFID tag such that signals may be received from the tag 100. When tags 100 are activated, data can be read from the plurality of tags embedded in the user's hand.

The exact embedding location may be varied to facilitate optimizing the tracking. For example, in one embodiment, one RFID tag is implanted under each finger to map out the position of each finger, and two RFID tags are embedded adjacent to, or in, the user's wrist to enable the orientation of the user's wrist to be mapped during use. As such, any user could walk up to a computer with a holographic or laser type interface that projects images instead of using a monitor. With a wave of their hand, the user can activate such a system and be immediately logged in. A three dimensional object could be displayed based on information stored on the user's RFID tags. As a password, only the user would know the correct movements of the objects, similar to the functionality of a combination lock. The system could then read the user's preferences also stored on the RFID tags. In one embodiment, a predetermined keyboard layout will be displayed.

In some applications, the transceiver and antenna are components of an interrogator or reader which can be configured either as a hand-held or a fixed-mount device. The interrogator emits the radio signals in range from one inch to one hundred feet or more, depending upon its power output, the radio frequency used, and other radio frequency considerations. When an RFID tag 100 passes through the electromagnetic radio waves, the tag 100 detects the signal and is activated. Data encoded in the tag is then transmitted by a modulated data signal through an antenna to the interrogator for subsequent processing.

An advantage of RFID systems is the non-contact, non-line-of-sight capability of the technology. Tags can be read through a variety of substances such as snow, fog, ice, paint, dirt, and other visually and environmentally challenging conditions where bar codes or other optically-read technologies would be useless. RF tags can also be read at remarkable speeds, in most cases responding in less than one hundred milliseconds.

The present invention was created to provide an interface with a holographic or a laser display. Moreover, in comparison to known systems, the current interface enables a user viewing system holographic displays to grab, rotate, and manipulate images displayed without being impeded by wires or a battery operated transmitter. More specifically, the system could facilitate the elimination of keyboards, the use of a mouse, and/or trackballs currently in use.

As used herein, coordinate fields are defined as orientation systems used in mapping the user's movements. There are two coordinate field types: system coordinate fields and device coordinate fields. A system coordinate field includes XYZ coordinates in the entire scope of the RF range that can pick up an RFID tag. A device coordinate field would include XYZ coordinates oriented in relation to the device. A device coordinate field is used to create a three-dimensional box that contains positions for activation of events. MultiApp meta data is user defined and related data that is useful to any application or operating system that the user interacts with. For example, such data may include, but is not limited to including the user's name, phone number, e-mail address, login information for remote servers, network locations of Matrix Maps, and/or user defined color schemes. The AppID is a unique identifier of the application name that is used to locate the specific configuration ID for that application. The DeviceID is a unique identifier of the device being used. This identifier is assigned to predefined devices that are commonly used among many users for the system in use. Otherwise a DeviceID links only to a matrix map field with the correct object. The scope resolution is a definition of the level of movements of the hand that will cause an event to be processed. The field of view is defined as the same as a coordinate field for a device. Hand gestures have a field of view relative to the size of the hand (specified in the matrix map for the user).

When comparing a digital field of view versus an analog field of view, in a digital field of view only specified three-dimensional boxes in the matrix map are activation boxes that produce an event. In an analog field of view, virtually all three-dimensional boxes produce an event, such that smaller movements of the hand can be detected, such as would be required to detect certain user movements, such as, but not limited to trackball movements, nob movements, writing your name with a pen, etc. The scope of an analog field of view is very small. To save space in the database an analog event in the matrix map is flagged analog and the area of the event is mapped out instead of specifying just one event per box a very large group of boxes are specified as the same event to track the movement of an RFID tag.

The event in the matrix map is defined is assigned to just one device and to only one field of view for that device. An event may only be mapped to one macro. An event can be digital or analog and it can specify a specific RFID tag in one position or specify all RFID tags in a specific position.

In the embodiment illustrated, three transceivers and a processing unit are used to triangulate the position of every RFID tag in the RF field. In a first situation, all inputs are from the RFID signals and the login user metadata. In such a situation, the system will simply triangulate all the RFID tags to XYZ positions relative to the entire RF field. In the event a new RFID tag is detected, the system will transmit the information to a login sub system which will verify the validity of the device. The login sub system will initialize the system and setup all configurations for any user to interact with the system. The login sub system will communicate with the meta data handler to load all needed configuration settings for any user that enters the RF field. All outputs to the “map to device system” will be in the format RXYZ wherein R is the RFID tag number, and XYZ are the coordinates. The “Map to Device” system receives each XYZ coordinate and determines if the RFID tag is manipulating a device. Initially the XYZ position is cross-checked with all the device field of views to determine if the newly detected RFID tag it is located in any of them. If it is, it translates the received information to that position ID. If it is not located in any of them, the system checks to see if the XYZ coordinates of all recent RFID tag broadcasted locations match a hand gesture in the hand gesture matrix map object.

In another situation, all inputs will be of the form RXYZ. In such a situation, all outputs will be of the form UFPD, wherein U represents a user ID, F represents a field of view, P represents a position in that field of view, and D represents a hand gesture. Moreover, each output will have a unique device id and the position will be the hand gesture ID for the specified matrix map of the user for hand gestures. Subsequently upon receiving such input, the “Map to Macro” system that takes events from the Map To Device system and determines if a signal should be sent to the application that is currently accessed and/or is currently focused. The application that has current focus is updated by the program register/pipe handler system and events that are received from the map to device system are checked in the current application that has focus for the necessary action. Sometimes an event will require direction of movement to be calculated, or a speed of direction or a vector of direction of a finger to be determined. Some events are stored in a queue to wait for another event to pop the queue and cause a macro or signal to be sent to the correct application.

In some situations, all inputs are from the Map to Device, in a UFPD form, as described above. In such a situation, all inputs from program register/pipe handler will be used to notify the system of a new program loading into memory or being removed from memory. The only outputs during such an event are defined by the matrix map of each application. If the user has no self-defined matrix map for an application then the default for the application is used with whatever device is default for that application.

The Login system that is sent any new user that enter's the RF field. Moreover, the login system will follow the login use case and will contact the user metadata handler to retrieve and load all user info. The Meta Data manager will process all user settings, and contact the correct Device Matrix Map database for the user. Once the correct device matrix map is contacted it will load the Map to Macro system and Map to Device system with the needed data.

The system will allow any device to be used as a form of interaction with the computer. The system has the capability to use anything from hand gestures to turning any tangable object into an object used for interacting with the computer. It is also entirely configurable which means a user interface is no longer defined. Applications can provide macros to be activated by any sequence of events the user or developer of software chooses. This system significatly changes the way in which software and hardware are designed. Software can now provide a more generic set of interface options that can be adapted to whatever device the specific user is more used to using. Acordingly, with the present invention, a system is provided that allows interaction with a user defined interface system. The metadata on the RFID tags provides the needed information to the interface to interpret the user's actions. As such, a user could establish pre-defined manipulation rules unique to that user or to that system, such that specific hand gestures in one system could make a device or application active. Computers can now adapt around a user's preferences instead of a user having to adapt to a new interface.

Although the embodiments described herein are discussed with respect to computer system interface, it is understood that the RF-enabled system and mapping methodology described herein is not limited to computer interface applications, but may be utilized in other interface applications.

The above-described embodiments of an RFID interface assembly provide a cost-effective and reliable means for interfacing with a system including non-tangible controls.

Exemplary embodiments of RFID methods and apparatus are described above in detail. The RFID components illustrated are not limited to the specific embodiments described herein, but rather, components of each RFID system may be utilized independently and separately from other components described herein.

While the invention has been described in terms of various specific embodiments, those skilled in the art will recognize that the invention can be practiced with modification within the spirit and scope of the claims.

What is claimed is:

1. A method for tracking the movement of a user's hand, said method comprising:
embedding a plurality of transmitters within a plurality of locations within the user's hand;
activating the transmitters;
receiving via a plurality of receivers signals transmitted from the plurality of embedded transmitters; and
determining a position of the user's hand based on the plurality of signals received.

2. A method in accordance with claim 1 wherein embedding a plurality of transmitters comprises embedding a plurality of radio frequency identification tags within the user's hand.

3. A method in accordance with claim 1 wherein embedding a plurality of transmitters further comprises embedding at least one transmitter in each finger on the user's hand to be tracked.

4. A method in accordance with claim 1 wherein determining a position of the user's hand comprises triangulating a position of each transmitter using the plurality of signals received.

5. A method in accordance with claim 1 further comprising continuously monitoring the position of the user's hand while the hand operates a virtual component.

6. A method in accordance with claim 1 wherein embedding a plurality of transmitters comprises embedding a plurality of transmitters within a glove worn on the user's hand.

7. A method in accordance with claim 1 further comprising displaying a position of the user's hand on a screen based on the plurality of signals received.

8. A method in accordance with claim 1 further comprising monitoring the movement of the user's hand as a computer is accessed via a holographic interface.

9. A wireless tracking system for tracking the movement of a user's hand that is a distance away from the tracking system, said system comprises:
a plurality of transmitters embedded in said user's hand at a plurality of different locations, said transmitters selectively activated and configured to wirelessly transmit data;
a plurality of receivers configured to receive wireless transmissions from said plurality of transmitters;
and a processor coupled to said plurality of receivers, said processor configured to determine a position of the user's hand based on the plurality of signals received.

10. A wireless tracking system in accordance with claim 9 wherein said plurality of transmitters comprise a plurality of radio frequency identification tags (RFID).

11. A wireless tracking system in accordance with claim 10 wherein said plurality of RFID tags are configured to store data therein.

12. A wireless tracking system in accordance with claim 9 wherein at least one transmitter is coupled within each finger of the user's hand to enable a location of each finger to be determined.

13. A wireless tracking system in accordance with claim 9 wherein a plurality of transmitters are coupled within a wrist of the user's hand to enable an rotational orientation of the user's hand to be determined.

14. A wireless tracking system in accordance with claim 9 wherein said process is further configured to triangulate a position of each said transmitter based on the plurality of signals received.
